(19) United States
(12) Patent Application Publication
(10) Pub. No.: US 2012/0144022 A1
(43) Pub. Date: Jun. 7, 2012

(54) CONTENT RECOMMENDATION THROUGH CONSUMER-DEFINED AUTHORITIES

(75) Inventors: Scott Porter, Sammamish, WA (US); Ryan Andrew Powell, Seattle, WA (US)

(73) Assignee: MICROSOFT CORPORATION, Redmond, WA (US)

(21) Appl. No.: 12/962,313

(22) Filed: Dec. 7, 2010

(51) Int. Cl. G06F 15/16

(52) U.S. Cl. 709/224

(57) ABSTRACT

A method for recommending content to a consumer in a manner proactively controlled by the consumer. The method is based on subscription to one or more consumer-identified authorities that receive content of potential interest to the consumer. The method comprises identifying an authority that shares an interest of the consumer, and establishing a communication channel through which information about the authority is passed to the consumer. The method further comprises monitoring a consumption activity of the identified authority, and offering one or more content recommendations to the consumer based on such monitoring.

### BACKGROUND

Electronic content providers use sophisticated methods to target consumers who may purchase their products. For example, commercial Internet websites may use functionality that recommends content—e.g., alternative or supplemental products—based on a visitor's consumption and/or browsing history. Optimized to increase profitability through sales and advertizing, such recommendations may be based on accumulated consumption and/or browsing data for numerous, accurately profiled consumers.

In contrast, the consumer has fewer and less powerful tools available to help make informed content choices. He or she may find that selecting from a forest of available content—including targeted content—is a daunting task. The busy consumer may not have the time or stamina to locate the most useful or enjoyable content based on his or her actual needs or interests.

Limited approaches now exist for addressing the problem outlined above. These include collaborative filtering via social networks. However, social networks (not unlike commercial websites) tend to flood the participant with content and content recommendations, such that he or she may be unable to separate useful information from noise—i.e., irrelevant information, frequent micro-updates, etc. Moreover, social networks typically afford little or no participant control over the manner, frequency, or mechanism with which recommendations are delivered. This factor can reduce the likelihood that a user will be exposed to and appropriately act upon a potentially useful recommendation.

### SUMMARY

One embodiment of this disclosure provides a method for recommending content to a consumer in a manner proactively controlled by the consumer. The method is based on subscription to one or more consumer-identified authorities that receive content of potential interest to the consumer. The method comprises identifying an authority that shares an interest of the consumer, and establishing a communication channel through which information about the authority is passed to the consumer. The method further comprises monitoring a consumption activity of the identified authority, and offering one or more content recommendations to the consumer based on such monitoring.

The summary above is provided to introduce a selected part of this disclosure in simplified form, not to identify key or essential features. The claimed subject matter, defined by the claims, is limited neither to the content of this summary nor to implementations that address problems or disadvantages noted herein.

### BRIEF DESCRIPTION OF THE DRAWINGS

FIG. 1 schematically shows an example environment for recommending content to a consumer in accordance with an embodiment of this disclosure.

FIG. 2 illustrates an example method for recommending content to a consumer in accordance with an embodiment of this disclosure.

FIG. 3 schematically shows an example computer system in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree.

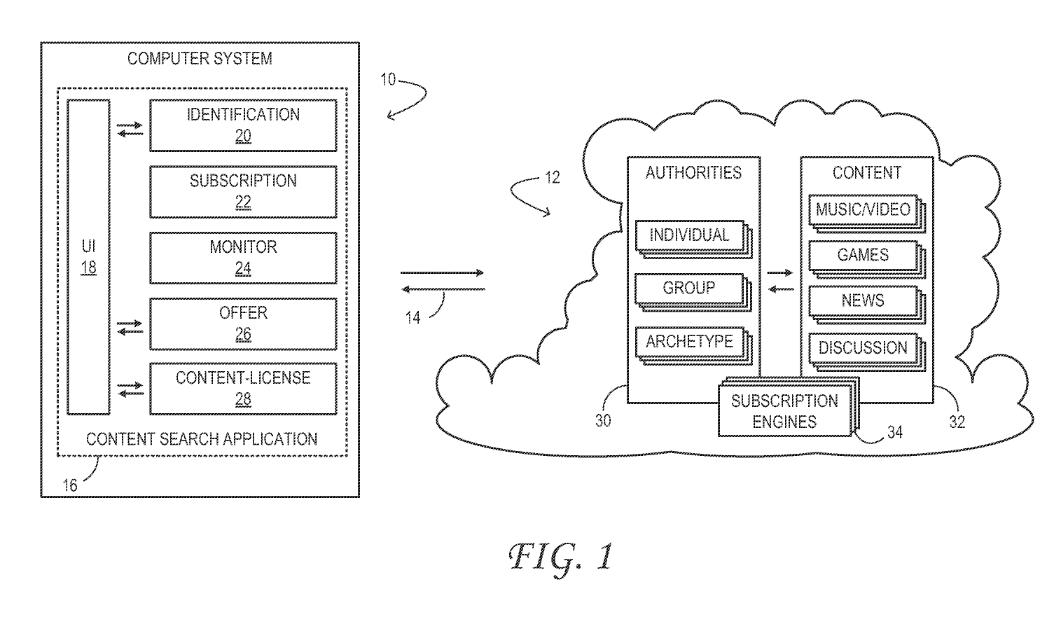

FIG. 1 schematically shows an example environment for recommending content to a consumer in a manner proactively controlled by the consumer. The drawing shows computer system 10 and cloud 12. The computer system and the cloud exchange data via communications link 14. In one embodiment, the communications link may comprise the internet. In other embodiments, the communications link may comprise a cellular network, a cable network, or virtually any suitable wired or wireless communication network.

Computer system 10 may be the consumer's desktop or laptop computer. In another embodiment, the computer system may be a network client or terminal to which the consumer is logged in. In other embodiments, the computer system may be the consumer's cellular telephone, stationary or handheld video game system, or portable media player.

Computer system 10 is configured to execute a content search application—viz., application 16 in FIG. 1. This application may be executed at the command of the consumer operating the computer system. Taken together, computer system 10 and application 16 embody a system for recommending content to the consumer.

As shown in FIG. 1, application 16 includes a plurality of code modules: user interface (UI) module 18, identification module 20, subscription module 22, monitor module 24, offer module 26, and content-license module 28. In some embodiments, the content search application may include still other modules. The various modules of the content search application cooperate to provide content-search functionality, as described hereinafter.

Continuing in FIG. 1, cloud 12 supports a plurality of authorities 30, which are identified by the consumer via content search application 16. Each authority is a network representation of a person or group that shares some interest of the consumer. The authorities may include social-network web pages, educational, organizational, or commercial web pages, user accounts of content consumers on commercial servers, etc. The authorities may be associated with individuals such as the consumer's friends and family members, to groups such as clubs, organizations, and professional societies, or to archetypes. An archetype authority is a virtual construct of the content search application, formed from a plurality of individuals and/or organizations to accurately mirror an interest of the consumer. As further described hereinafter, content search application 16 is configured to make content recommendations to the consumer based on the consumption activity of the various authorities identified.

Cloud 12 also supports content 32 in various forms and locations. The content may include, for example, video (e.g., movies and television), music, games, news, and discussion. The content may be downloadable or streaming. It will be understood that the content categories recited here are examples only, as virtually any form of digital content may be supported within the cloud.

Cloud 12 also includes subscription engines 34. The subscription engines are code modules running on commercial servers, or elsewhere, that route content 32 to the various authorities subject to appropriate rules and licensing.

The environment described above enables various methods for recommending content to a consumer. The methods will now be described with continued reference to the above configurations. It will be understood, however, that the methods here described, and others fully within the scope of this disclosure, may be enabled by other configurations as well. The methods may be entered upon any time application 16 is running, and may be executed repeatedly. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

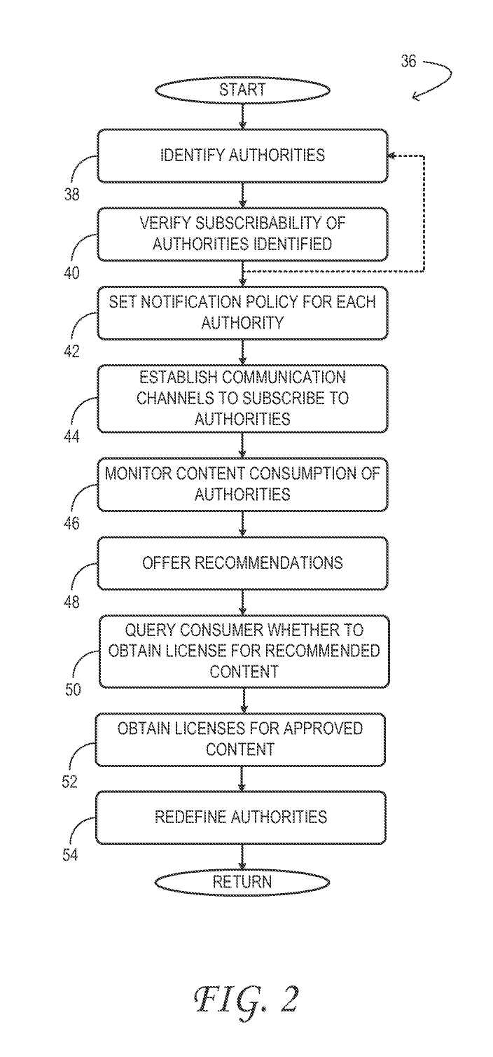

FIG. 2 illustrates an example method 36 for recommending content to a consumer in a manner proactively controlled by the consumer. The method is based on subscription, by the consumer, to one or more authorities that receive content of potential interest to the consumer. As further described below, the authorities are identified by the consumer and may be changed or removed by the consumer. Accordingly, the consumer retains a high level of control of the content-search process.

At 38 one or more candidate authorities are identified via identification module 20 in connection with user-interface module 18. In one embodiment, the user-interface module may query the consumer to specify an authority. For example, if Renee is the consumer's friend, and if the consumer and Renee share common interests in cycling, then the consumer may, in response to a query, specify Renee as an authority with respect to cycling. If Maria is the consumer's sister, and if the consumer and Maria share common interests in folk music, then the consumer may specify Maria as an authority with respect to folk music. Renee and Maria are examples of individual authorities, but group authorities may be identified as well. For example, the consumer may specify Friends of Folk Music in Portland, Oreg. as a group authority with respect to folk music.

In another embodiment, identification module 20 may infer a suitable individual or group authority based on an interest of the consumer. Via user interface module 18, the consumer may select a topic of interest—cycling or folk music, for example. The identification module may then search one or more accessible networks for an appropriate individual or group authority sharing that interest. For example, the module may search various social-network web pages for the keyword ‘cycling’. An individual or group associated with the web page on which the keyword is found may then be identified as an authority.

In another embodiment, the search may be further restricted by other constraints besides one or more keywords. For example, the identification module may search for an individual in Portland, Oreg., between the ages of twenty-five and thirty-five, who subscribes to a cycling blog and reads more than fifteen cycling blog posts per week. If such an individual is found, he or she may be identified as an authority.

In another embodiment, identification module 20 may determine the interest of the consumer without explicit input from the consumer. It may, for example, keep track of the consumer's prior consumption activity—browsing, purchasing, etc.—and infer the interest based on the prior consumption activity.

In some scenarios, an individual or group authority as identified above may provide a suitable representation of a consumer's interest. In other scenarios, a more accurate representation may be constructed based on a plurality of content consumers that collectively embody an archetype. Accordingly, identification module 20 may define an archetype authority based on an appropriate property or set of properties of individual and/or group consumers. For example, the identification module may define a folk-music archetype authority based on all purchasers of The Mendoza Trio—Unplugged from music vendors on the internet. Purchasers contributing to the archetype may be further restricted by age range, location, etc.

At 40 the subscribability of the identified authorities is verified via subscription module 22. It is possible, for example, that one or more of the authorities is not public, has blocked access, and/or refuses to be subscribed to. When that occurs, the authority may be removed from consideration, and processing may continue with the remaining authorities. In another embodiment, method 36 may return to 38 for identification of an alternative authority. At this stage of the method, the subscription module may also determine which, if any, preconditions the authority may place on subscription by the consumer. Such preconditions may include registration on a web site, payment of a license fee, etc.

At 42 the consumer, via subscription module 22, sets a notification policy for each of the candidate authorities identified. In one embodiment, the module may query the consumer for a notification policy for each authority identified. This action allows the user to consent to being notified of the consumption activities of each authority identified, or, to reject being notified. The consumer may choose to reject being notified if notification require payment of an excessive license fee, if it automatically place the consumer on a mailing list, require the consumer to install software on his or her system, and/or sacrifice the consumer's privacy, for example.

If the consumer consents to being notified, various parameters of the notification policy may be defined at this stage. The notification policy may determine when and how the one or more content recommendations are offered to the consumer. This may involve, for example, defining a frequency of the notification and/or an event that trigger notification. For example, the consumer may specify that he or she will be notified every time Renee views cycling content, or every third time Maria downloads a folk tune.

The notification policy may further define how the content recommendation is to be reported to the consumer. In the various embodiments contemplated herein, content recommendations may be reported via email, short-message service (SMS) messaging, telephone, a social networking website, or via user-interface module 18, for example.

At 44 subscription module 22 establishes one or more communication channels through which information about the authorities are passed to the consumer. This action enables the consumer to subscribe to the authorities. It may include, for example, accessing a dedicated portal of a commercial internet web site. In other examples, establishing an appropriate communication channel may include ‘friending’ individuals or groups identified as authorities—e.g., Renee and Maria.

At 46 monitor module 24 monitors the content-consumption activities of the authorities, via the communication channels established above. The monitored consumption activities may comprise downloading or consumption of video such as movies and television, music, games, news, and discussion. In one embodiment, the monitored consumption activity may include a prior consumption activity—e.g., downloads in the last week, the last month, etc.

At 48 offer module 26 offers the consumer one or more content recommendations based on the results of the above monitoring, subject to the notification policies defined at 42. For instance, the offer module may notify the consumer, by email, of the cycling blog that Renee is reading each time she reads one. Via a message on his social-network web page, the consumer may be notified monthly of the folk songs Maria has downloaded.

At 50 license module 28 queries the consumer to determine whether or not to obtain a required license for content referenced in the one or more content recommendations. If the consumer agree to obtain the license, then the license module, at 52, may obtain it. In another embodiment, the consumer may not necessarily be queried; the license module may automatically obtain licenses for recommended content of a particular category, or by a particular authority.

At 54, identification module 20 may receive information—e.g., from one or more of the other modules—that reflects the suitability of a defined authority. For instance, if the consumer consistently fails to follow the recommendations of an authority, that authority may be automatically removed from consideration. Or, if the authority is an archetype authority, it may be redefined. In one embodiment, redefining the archetype authority may include broadening the search for individuals or groups conforming to the archetype by relaxing various restrictions of the search—age range or location, for example. This action may be taken if the authority provides less than a threshold frequency of recommendations. In another embodiment, redefining the archetype may include narrowing the search for individuals or groups by adding restrictions to the search. This action may be taken if the authority provides more than a threshold frequency of recommendations, or if the recommendations are infrequently followed by the consumer.

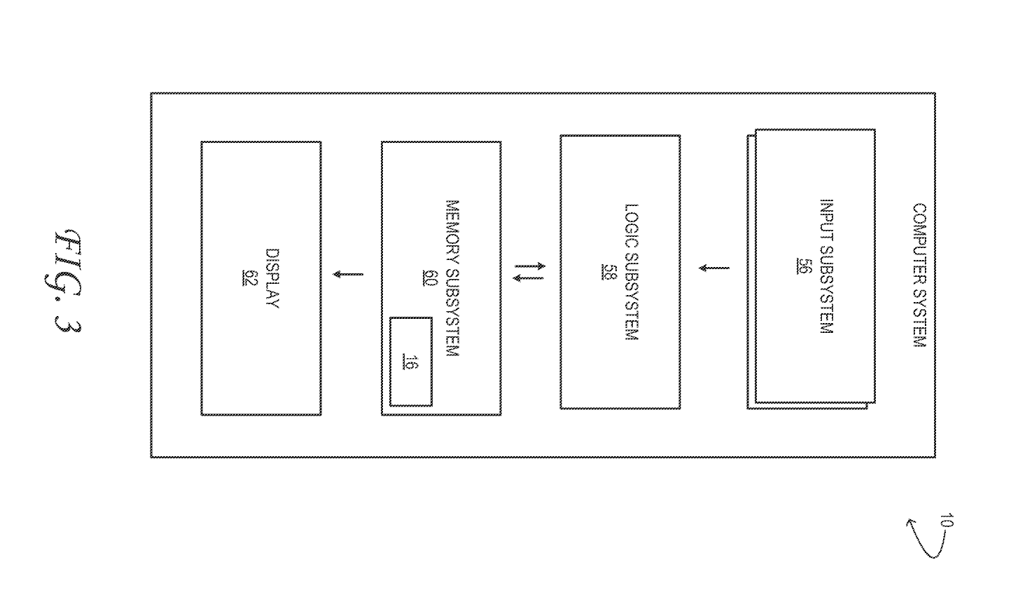

As noted above, the methods and functions described herein may be enacted via computer system 10, shown schematically in FIG. 3. The computer system includes input subsystem 56, logic subsystem 58, memory subsystem 60, and display 62. In one embodiment, the input subsystem may include a microphone, a keyboard, and a mouse. In other embodiments, the input subsystem may include a track pad or track ball. The display may include a color liquid-crystal display (LCD) screen, which, in some embodiments may underlay a track pad for touch-screen functionality. The computer system may be configured to receive input via one or more input devices and to direct output to one or more output devices, including display 62. In some embodiments, the computer system may also direct output to a loudspeaker. The computer system may receive other forms of input and transmit other forms of output as well—via communications link 14, for example. Further, through operative coupling of logic subsystem 58 and memory subsystem 60, the computer system may be configured to enact any method—i.e., computation, processing, or control function—described herein.

More specifically, memory subsystem 60 may hold instructions that cause logic subsystem 58 to enact the various methods. To this end, the logic subsystem may include one or more physical devices configured to execute instructions. For example, the logic subsystem may be configured to execute instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors configured to execute software instructions. Additionally or alternatively, the logic subsystem may include one or more hardware or firmware logic machines configured to execute hardware or firmware instructions. The logic subsystem may optionally include components distributed among two or more devices, which may be remotely located in some embodiments.

Memory subsystem 60 may include one or more physical, non-transitory, devices configured to hold data and/or instructions executable by logic subsystem 58 to implement the methods and functions described herein. When such methods and functions are implemented, the state of the memory subsystem may be transformed (e.g., to hold different data). The memory subsystem may include removable media and/or built-in devices. The memory subsystem may include optical memory devices, semiconductor memory devices, and/or magnetic memory devices, among others. The memory subsystem may include devices with one or more of the following characteristics: volatile, nonvolatile, dynamic, static, read/write, read-only, random access, sequential access, location addressable, file addressable, and content addressable. In one embodiment, the logic subsystem and the memory subsystem may be integrated into one or more common devices, such as an application-specific integrated circuit (ASIC) or so-called system-on-a-chip. In another embodiment, the memory subsystem may include computer-system readable removable media, which may be used to store and/or transfer data and/or instructions executable to implement the herein-described methods and processes.

The terms ‘module’ and/or ‘engine’ are used to describe an aspect of computer system 10 that is implemented to perform one or more particular functions. In some cases, such a module or engine may be instantiated via logic subsystem 58 executing instructions held by memory subsystem 60. It will be understood that different modules and/or engines may be instantiated from the same application, code block, object, routine, and/or function. Likewise, the same module and/or engine may be instantiated by different applications, code blocks, objects, routines, and/or functions in some cases.

As shown in FIG. 3, computer system 10 may include components of a user interface—input subsystem 56 and various output devices, such as display 62. Display 62 may provide a visual representation of data held by memory subsystem 60. As the herein-described methods and processes change the data held by the memory subsystem, and thus transform the state of the memory subsystem, the state of the display may likewise be transformed to visually represent changes in the underlying data. The display may include one or more display devices utilizing virtually any type of technology. Such display devices may be combined with logic subsystem 58 and/or memory subsystem 60 in a shared enclosure, or such display devices may be peripheral display devices.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A method for recommending content to a consumer in a manner proactively controlled by the consumer, the method based on subscription to one or more authorities that receive content of potential interest to the consumer, the method comprising:
identifying an authority sharing an interest of the consumer;
establishing a communication channel through which information about the authority is passed to the consumer;
monitoring a consumption activity of the identified authority; and
offering one or more content recommendations to the consumer based on said monitoring.

2. The method of claim 1, wherein the consumption activity includes a prior consumption activity, and wherein the one or more content recommendations offered to the consumer are responsive to the prior consumption activity.

3. The method of claim 1 further comprising setting a notification policy that determines when and how the one or more content recommendations are offered to the consumer.

4. The method of claim 3 further comprising querying the consumer for the notification policy.

5. The method of claim 1, wherein identifying the authority comprises querying the consumer to specify the authority.

6. The method of claim 1, wherein identifying the authority comprises inferring the authority based on the interest of the consumer.

7. The method of claim 6, wherein inferring based on the interest of the consumer comprises inferring based on a prior consumption activity of the consumer.

8. The method of claim 6 further comprising querying the consumer to accept or reject receiving the one or more content recommendations from the authority.

9. The method of claim 1, wherein the authority is a group of consumers.

10. The method of claim 1, wherein the authority is an individual consumer.

11. The method of claim 1, wherein the authority is an archetype consumer.

12. The method of claim 11, wherein the consumption activity of the authority is derived from consumption activity of a plurality of consumers collectively embodying the archetype consumer.

13. The method of claim 1 further comprising obtaining a license to consume content referenced in the one or more content recommendations.

14. The method of claim 13, wherein the license is obtained automatically.

15. The method of claim 13 further comprising querying the consumer to accept or reject obtaining the license.

16. The method of claim 1, wherein the consumption activity comprises receiving one or more of video, music, news, and discussion.

17. A system for recommending content to a consumer in a manner proactively controlled by the consumer, the system comprising:
an identification module configured to identify an authority sharing an interest of the consumer;
a subscription module configured to establish a communication channel through which information about the authority is passed to the consumer;
a monitor module configured to monitor a consumption activity of the identified authority; and
an offer module configured to offer one or more content recommendations to the consumer based on said monitoring.

18. The system of claim 17 further comprising a licensing module configured to obtain a license to consume content referenced in the one or more content recommendations.

19. A method for recommending content to a consumer in a manner proactively controlled by the consumer, the method based on subscription to one or more authorities that receive content of potential interest to the consumer, the method comprising:
constructing an archetype authority based on a plurality of authorities sharing an interest of the consumer;
establishing a communication channel through which information about the archetype authority is passed to the consumer;
monitoring a consumption activity of the archetype authority constructed; and
offering one or more content recommendations to the consumer based on said monitoring.

20. The method of claim 19 further comprising refining the archetype authority based on an extent to which the consumer accepts the one or more content recommendations.
